(19) United States
(12) Patent Application Publication
(10) Pub. No.: US 2007/0214267 A1
(43) Pub. Date: Sep. 13, 2007

(54) Security server monitoring device and load distribution system

(76) Inventors: Takao Ogura, Kawasaki (JP); Kohei Iseda, Kawasaki (JP); Hirobumi Suzuki, Kawasaki (JP); Koji Harada, Kawasaki (JP)

Correspondence Address: KATTEN MUCHIN ROSENMAN LLP, 575 MADISON AVENUE, NEW YORK, NY, 10022-2585, US

(21) Appl. No.: 11/715,831

(22) Filed: Mar. 8, 2007

(30) Foreign Application Priority Data
Mar. 9, 2006 (JP) 2006-63984

(51) Int. Cl. G06F 15/173

(52) U.S. Cl. 709/226

(57) ABSTRACT

A security server monitoring device is provided that performs quick redistribution of loads when a server load increases due to virus infections. A security server performs a virus check on data flowing through a network, thus statistical data relating to detected viruses can be obtained. For example, future communication traffic and increases and decreases in server loads are predicted using statistical information such as the number of virus infections (number of virus infections per unit of time), and on the basis of this prediction, a security server allocated to a path is quickly changed from a security server in which a high load is predicted to a security server with a comparably low load.

### CROSS-REFERENCE TO RELATED APPLICATIONS

This application is based upon and claims the benefit of priority from the prior Japanese Patent Application No. 2006-63984, filed on Mar. 9, 2006, the entire contents of which are incorporated herein by reference.

### BACKGROUND OF THE INVENTION

1. Field of the Invention

The present invention relates to a security server monitoring device for monitoring a security server in a network, in which the security server checks for computer viruses, and particularly relates to a security server monitoring device that can distribute loads on security servers in accordance with an increase in traffic due to computer virus infections.

2. Description of the Related Art

As the Internet has come into general use, the threat of a wide variety of computer viruses, worms and the like (referred to as viruses below) has become greater, thus the need of maintaining information security on a network has arisen. A service has recently come about in which communication data that flows through a network is fed through a security server, which checks for viruses, in order to secure this type information security. In the future, as various communication data is fed through this type of security server, there is a risk that the server load (processing load) of the security sever will increase, the throughput of the communication traffic will be lowered, and traffic will concentrate in communication links near the security server, leading to an imbalance in traffic. At this point it is desirable to have a plurality of security servers.

Conventional load distribution for servers has been performed according to the server loads (for example, the utilization rate of the CPU), the number of requests, and the like.

Japanese Unexamined Patent Application No. 2003-216445 discloses a virus check method that does not place a large load on the hardware that performs the virus check, in which a virus infection check is performed on data in a computer, confirmation is made that the data in the computer is not infected with a virus, and then a check is performed as to whether data read in from outside the computer is infected with a virus.

Also Japanese Unexamined Patent Application No. 2003-149435 discloses a network concentration monitoring method in which an updated virus vaccine is downloaded at fixed intervals for information devices that structure a network, and furthermore information concerning the structure and utilization conditions of resources in the information devices is obtained via the Internet, the structure and utilization conditions of resources in each information device in the network are recognized, and inappropriate use and inappropriate connections are detected.

The infection levels of viruses such as Code Red and Nimda are great, attacking the network resources, and increasing the load on servers, thus it is necessary to respond to these types of viruses in the early stages. For example, a situation can be conceived in which several tens of thousands of service subscribers access a security server through a VPN (Virtual Private Network). The time necessary for switching the VPNs is considerable when a portion of the subscribers (for example, ten thousand) is switched to another security server in order to redistribute the load. When using conventional methods to perform switching of only the server load of the security servers, the possibility arises of the switching not being in time to meet the occurrence of a major virus infection.

### SUMMARY OF THE INVENTION

The present invention, in order to solve the problems described above, provides a security server monitoring device and a load distribution system which can perform load distribution quickly when a server load increases due to virus infections.

A first structure of a security server monitoring device of the present invention, which is for achieving the objects described above, in which the security server monitoring device monitors the load on a first security server which is allocated to a path in a network and which checks for computer viruses included in data flowing through the path, the security server monitoring device having a gathering unit for gathering statistical information, from the first security server, relating to computer viruses in the first security server, a determination unit for determining whether the load condition of the first security server exceeds a first load level on the basis of the statistical information relating to the first security server, and an allocation unit for allocating a second security server to the path in place of the first security server when the determination unit determines that the load condition of the first security server exceeds the first load level.

A second structure of the security server monitoring device of the present invention in which in the above first structure, the gathering unit gathers statistical information relating to the second security server, when the determination unit determines that the load condition of the first security server exceeds a fixed load level, the determination unit determines whether the load condition of the second security server is less than a second load level on the basis of statistical information relating to the second security server, and when the determination unit has determined that the load condition of the second security server is less than the second load level, the allocation unit selects the second security server from among a plurality of security servers which are not the first security server, and allocates the second security server to the path.

A third structure of the security server monitoring device of the present invention in which in the above first or second structure the allocation unit allocates the second security server to a portion of a plurality of paths to which the first security server is allocated.

A fourth structure of the security server monitoring device of the present invention in which in the above third structure the allocation unit selects the portion of the paths on the basis of the number of subscribers accommodated in each path or on the basis of the communication volume in each path.

A fifth structure of the security server monitoring device of the present invention in which in the above third structure the allocation unit selects the portion of the paths on the basis of the network link costs for each path to the second security server.

A sixth structure of the security server monitoring device of the present invention in which in the above first structure the gathering unit gathers load information relating to the first security server from the first security server, and the determination unit determines whether the load condition of the first security server exceeds the first load level on the basis of the statistical information and the load information relating to the first security server.

A seventh structure of the security server monitoring device of the present invention in which in the above second structure the gathering unit gathers load information relating to the second security server from the second security server and the determination unit determines the load condition of the second security server on the basis of the statistical information and the load information relating to the second security server.

An eighth structure of the security server monitoring device of the present invention in which in the above first structure the statistical information includes information relating to the number or rate of computer virus infections detected in a unit of time.

A ninth structure of the security server monitoring device of the present invention in which in the above eighth structure the statistical information includes information relating to the infection levels or the degree of danger of the detected computer viruses.

A first structure of a load distribution system of the present invention in which the load distribution system has a first security server which is allocated to a path in a network and which checks for computer viruses included in data flowing through the path, and has a security server monitoring device which monitors the load of the first security server, in which the first security server has a generating unit for generating statistical information relating to computer viruses on the basis of a computer virus check result, has a first determination unit for determining whether the load condition of the first security server exceeds a first load level on the basis of statistical information relating to the first security server, and has a notification unit for notifying the security server monitoring device of the determination result when the first determination unit determines that the load condition of the first security server exceeds the first load level, and the security server monitoring device has a receiving unit for receiving the determination result from the notification unit, and an allocation unit for allocating a second security server to the path in place of the first security server when the determination result is received.

A second structure of the load distribution system of the present invention in which in the first structure of the load distribution system the security server device has a gathering unit for gathering statistical information relating to the second security server on the basis of the determination result received by the receiving unit, and has a second determination unit for determining whether the load condition of the second security server is less than a second load level on the basis the statistical information relating to the second security server, and when the second determination unit determines that the load condition of the second security server is less than the second load level, the allocation unit selects the second security server from among a plurality of security servers which are not the first security server, and allocates the second security server to the path.

A third structure of the load distribution system of the present invention in which in the first or the second structure of the load distribution system the allocation unit allocates the second security server to a portion of a plurality of paths to which the first security server is allocated.

A fourth structure of the load distribution system of the present invention in which in the third structure of the load distribution system, the allocation unit selects the portion of the paths on the basis of the number of subscribers accommodated in each path or on the basis of the communication volume in each path.

A fifth structure of the load distribution system of the present invention in which in the above third structure of the load distribution system, the allocation unit selects the portion of the paths on the basis of the network link costs for each path to the second security server.

A sixth structure of the load distribution system of the present invention in which in the first structure of the load distribution system, the generating unit generates load information relating to the first security server, and the first determination unit determines whether the load condition of the first security server exceeds the first load level on the basis of the statistical information and the load information relating to the first security server.

A seventh structure of the load distribution system of the present invention in which in the second structure of the load distribution system, the gathering unit gathers load information relating to the second security server from the second security server and the second determination unit determines whether the load condition of the second security server is less than the second load level on the basis of the statistical information and the load information relating to the second security server.

An eighth structure of the load distribution system of the present invention in which in which in the first structure of the load distribution system the statistical information includes information relating to the number or rate of computer virus infections detected in a unit of time.

A ninth structure of the load distribution system of the present invention in which in which in the eighth structure of the load distribution system, the statistical information includes information relating to the infection levels or the degree of danger of the detected computer viruses.

The present invention can predict a load increase on a security server on the basis of statistical information relating to viruses which is based on a virus check result, can change the security allocated to a path quickly and efficiently, and can suppress notification faults that arise due to increases in the load of a security server.

### BRIEF DESCRIPTION OF THE DRAWINGS

FIG. 1 is a drawing showing an entire structure of a network;

FIGS. 2A to 2C are drawings showing block structures of a security server 10, a security server monitoring device 100 and a security gateway;

FIG. 3 is a drawing showing virus check result data in the security server 10;

FIGS. 4A and 4B are drawings showing an example of statistical information accumulated in the security server 10; and

FIG. 5 is a drawing showing a flowchart of the processing performed in the security server monitoring device 100.

### DESCRIPTION OF THE PREFERRED EMBODIMENTS

An explanation of an embodiment of the present invention will be given below. However, this embodiment does not limit the technical scope of the present invention.

It is possible to obtain statistical information relating to a detected virus since a security server is performing a virus check on data flowing through a network. Thus, in the present invention, for example, statistical information such as the number of virus infections (the number detected in a unit of time) is used to predict increases and reductions in future communication traffic and server loads, and based on these predictions the present invention quickly changes the security server allocated to a path from a security server in which a high load is expected to a security server with a comparably low load.

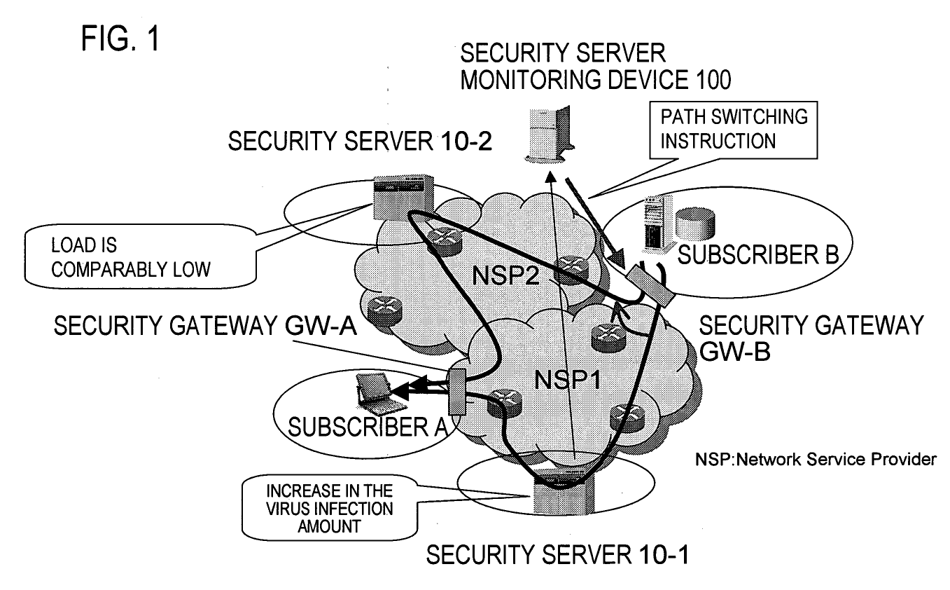

FIG. 1 is a drawing showing the complete structure of a network. The network structure is formed from a plurality of network service providers (NSP), which provide various data communication transmission services. NSP 1 and NSP 2 provide security services, which perform virus checks on e-mails, HTTP communication and the like, and in order to provide these security services to subscribers the NSP 1 and the NSP 2 perform communication via security servers 10-1 and 10-2 (referred to as security servers 10 below, except when distinguishing between them), respectively.

In order to provide communication through the security servers 10, paths are set to pass through the security servers 10 using L2TP, PPTP, IP-VPN, or the like. These paths are set originating from gateways that extend from subscriber terminals or subscriber nets to the outside. In this embodiment of the present invention paths are set from the gateways, and the gateways perform switching of the paths when another security server is allocated to a path in order to distribute the load on the security servers. This embodiment of the present invention refers to the gateways as security gateways (GW).

In FIG. 1, according to the communication condition, data from a subscriber terminal B goes through the network of the NSP 1, undergoes a data security check by the security server 10-1, and is transmitted to a subscriber terminal A.

At this time, when a load distribution determination method, for the present invention, to be described below, determines that load redistribution is necessary for the security server 10-1, the path for the data from the subscriber terminal B is switched from the network of the NSP 1 to the network of the NSP 2 through path setting control in a security gateway GW-B in the network to which the subscriber terminal B belongs. More specifically, the security server 10-2 of the NSP 2 is allocated in place of the security server 10-1 of the NSP 1 in the path from GW-B, thus a path is set to the security server 10-2 of the NSP 2. Data transmitted from the GW-B undergoes a security check by the security server 10-2, and is transmitted to the subscriber terminal A.

In this embodiment of the present invention, for distributing loads in the security servers 10, a security server monitoring device 100 is disposed which changes a server allocated to a path in accordance with the load condition of the security servers 10. The security server monitoring device 100 can communicate with the security server 10 of each network, gathers statistical information and server load information, relating to viruses, that is generated and accumulated in each security server 10, and on the basis of this information, monitors the load condition of each security server 10 to determine the need of load redistribution. More specifically, the security server monitoring device 100 determines whether the load condition exceeds a fixed level. Then, in order to switch the path, which passes through the security server whose load condition has exceeded the fixed value, to a path that passes through another security server with a comparably low load, the security server monitoring device 100 allocates another security server to the path, and instructs the security gateway (GW), which sets the path to the security server, to switch paths.

Note that a security server itself may determine the need for load redistribution on the basis on statistical information relating to viruses, server load information, and the like, and then based on the determination result, may notify the security server monitoring device 100 of a request for another security server to be allocated. In this case, the security server monitoring device 100 instructs the security gateway to switch the path in which the security server that determined the need for a change in allocation is placed, to a path in which a security server is placed that has a comparably low load.

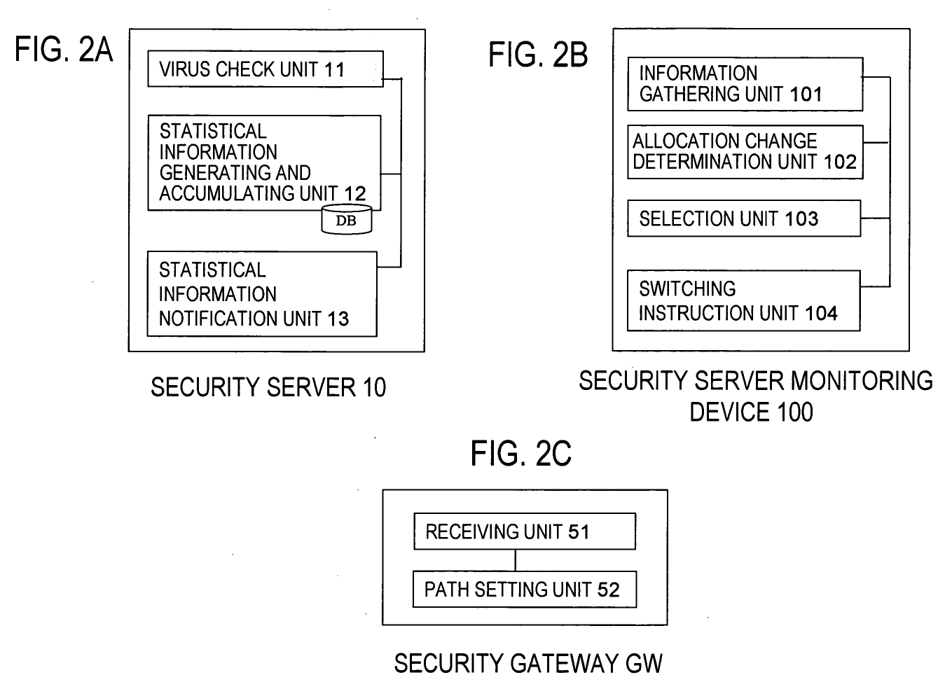

FIGS. 2A to 2C are drawings showing block structures of the security server 10, the security monitoring device 100 and the security gateway. FIG. 2A is a block structure of the security server 10, in which the security server has a virus check unit 11 which checks for viruses in e-mails or in HTTP data, a statistical information generating and accumulating unit 12 which generates and accumulates statistical information relating to viruses on the basis of the check results, and a statistical information notification unit 13 which notifies the security server monitoring device 100 of accumulated statistical information.

FIG. 2B is a block structure of the security server monitoring device 100, in which the security server monitoring device has an information gathering unit 101 which gathers statistical information and server load information that is communicated by the security server 10, an allocation change determination unit 102 that determines the need to change the security server allocated to a path on the basis of the statistical information and the load information, a selection unit 103 which selects a security server to be reallocated to the change location and selects a path (or a security gateway) to be allocated to this reallocated security server, when a determination is made that a change in allocation is needed, and a switching instruction unit 104 which instructs the selected security gateway to switch the path to the reallocated security server.

FIG. 2C is a block structure of the security gateway (GW), in which the security gateway has a receiving unit 51 for receiving switching instructions from the security server monitoring device 100 and a path setting unit 52 for setting a path on the basis of the switching instructions.

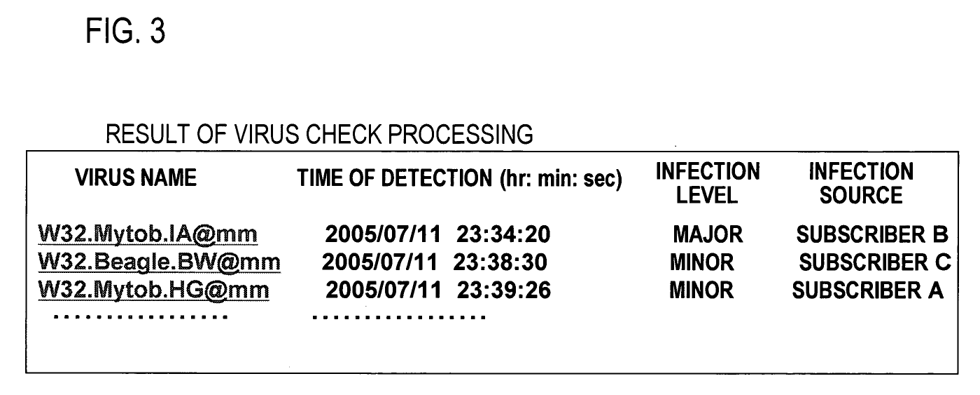

FIG. 3 is a drawing showing virus check result data in the security server 10. As shown in FIG. 3 the security server 10 performs a virus check on data flowing through the network, and when a virus is detected, records the virus name, the time of detection, the infection level, and the infection source. The infection level shows the degree of ease in which the virus can infect computers, and furthermore information relating to the degree of danger may also be recorded. The degree of danger shows the level of damage that is generated when the virus infects a computer.

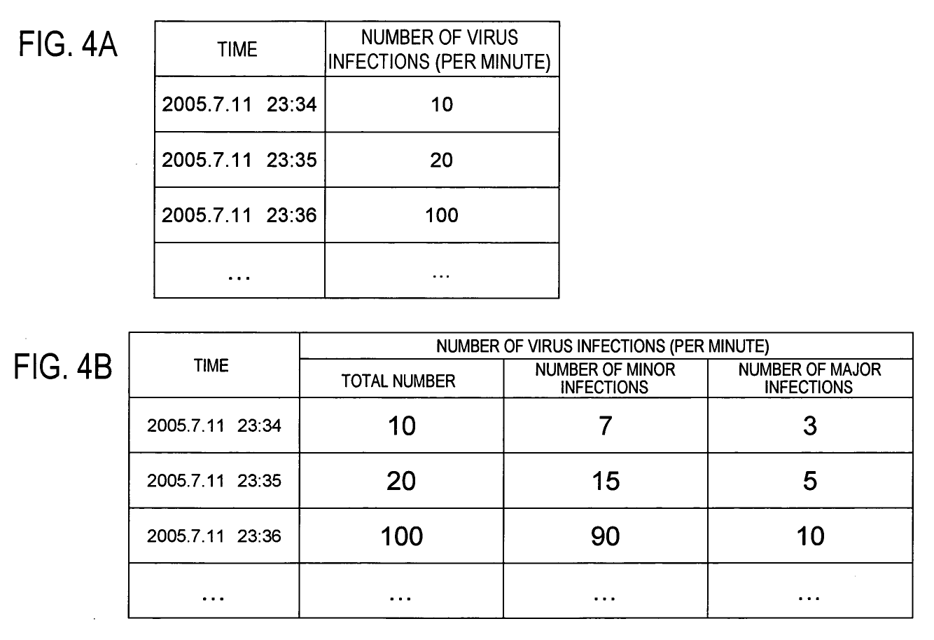

FIGS. 4A and 4B are drawings showing an example of statistical information accumulated in the security server 10. The security server 10 processes statistically the virus check result data shown in FIG. 3 and produces statistical information such as shown in FIGS. 4A and 4B at fixed time intervals. The statistical information, as shown in FIG. 4A as an example, is the number of viruses detected in a unit of time. Also the statistical information, as shown in FIG. 4B, may also classify the number of viruses detected in a unit of time according to the degree of the infection level. Also each virus may be classified by the degree of danger of the viruses and the type of viruses. By classifying each virus according to the infection level, the degree of danger and the type, the virus infection condition can be ascertained with more detail, and allocation change determination can be performed with higher accuracy. For example, when a virus infection with a high degree of danger is detected, even if the number of infections is low, a determination is made to change the allocation of the security servers more quickly that the normal determination method.

Next, an explanation will be given of an allocation change determination method for the security servers. This allocation change determination method is executed by the security server monitoring device 100 or the security server 10. In the present embodiment the security server monitoring device 100 will execute the method.

The security server monitoring device 100 receives from the security server 10 load information and statistical information for that security server, and then performs allocation change determination according to the conditional expression below.

Conditional expression (A): α<the server load and β<the number of virus infections per minute (α=0.6 β=100).

α and β are each server loads, the threshold values of the number of virus infections per minute, and when the server load exceeds 0.6 (for example, the CPU utilization rate is 60%), and the number of virus infections per minute exceeds 100, a determination is made that a change in the allocation of the security servers is needed.

For example, a virus infection increase rate for a unit of time may be used in place of the number of virus infections per unit of time. For example, when the current number of virus infections exceeds a prior number of virus infections per unit of time by ten times (ten times being the threshold value β), the security server monitoring device 100 determines that a change in the allocation of that security server is needed. Also, the number by which the virus infections increase may also be used. For example, when the current number of virus infections exceeds a prior number of virus infections per unit of time by 100 (100 being the threshold value β), the security server monitoring device 100 determines that switching that security server is needed.

In the conditional expression described above, as an example, the threshold value for the server load α=0.6 was set, however, this value is set lower than the conventional set values (for example, about 0.8). When the number of virus infections exceeds the threshold value β, the security server monitoring device 100 can predict a further increase in the server load, and thus quickly changes the security server allocated to the path, thereby switching the path. The security gateway is some cases provides for a plurality of subscribers, and in other cases acts as a home gateway for a residence in which one gateway is installed for each subscriber. When the security gateway is one in which one gateway is installed for each subscriber, the number of security gateways used to switch a path increases, thus there is a need to quickly switch the paths by using a low threshold value.

Also, determination may also be performed using the threshold value β of the number of virus infections, without using a threshold value of the server load.

Next, an explanation will be given of selection methods for a security server to be reallocated. The security server monitoring device 100 will execute these selection methods. When the allocation change determination method described above determines the need to change the allocation of a security server, there is a need to determine which security server and how many paths to allocate to the security server. Security servers that can be reallocated that are selected by these selection methods are termed reallocation security servers. Three selection methods will be shown below.

(1) The security server monitoring device 100 selects a security server that can be reallocated, with for example, the conditional expression below.

Conditional expression (B): α>the server load and β>the number of virus infections per minute (α=0.2 and β=10).

α and β are each server loads, the threshold values of the number of virus infections per minute, and when the server load is less than 0.2 (for example, the CPU utilization rate is 20%), and the number of virus infections per minute is less than 10, a determination is made that the security server is one which can be reallocated. More specifically, a security server is selected that has sufficient extra capacity to be allocated to an additional path, in which the security server has a server load and number of virus infections that are both low.

When there are a plurality of security servers that satisfy the conditional expression (B), for example, the security server with the lowest server load and number of virus infections is selected.

(2) The security server monitoring device 100 selects a preinstalled backup security server. The backup security server is not used under normal conditions, but is only used when the allocation change determination described above is that a change in the allocation of a security server used under normal conditions is needed.

(3) The security server monitoring device 100 selects a predetermined security server from another NSP (Network Service Provider). A contract is reached in advance with another NSP to receive permission to use security servers from the other NSP. The security servers on the other NSP are not normally used by the NSP (the other NSP uses these security servers under normal conditions), but are only used when a security server used by the NSP under normal conditions determines the need for a change in allocation using the allocation change determination described above. There are many cases in which the number of virus infections vary according to the time period among providers, and in the case in which in one provider the number of virus infections is large, there are cases in which infections are almost nonexistent in other provides. In this type of case, the server loads on the security servers of other providers are sufficiently low, and the security gateways (or subscriber terminals) have sufficient extra capacity to have additional paths allocated to them.

Next, an explanation will be given of selection methods for paths to be switched. The security server monitoring device 100 executes this path selection method. When a security server is determined to need a change in allocation, not all of the paths allocated to that security server need to be switched to the selected reallocation security server. The security server monitoring device 100 may select a portion of the paths from the security server in which the need for a change in allocation has been determined, the extent of the portion of paths being sufficient to lower the server load condition sufficiently below the conditional expression (A). Then that portion of paths may, for example, be allocated to the selected reallocation security server on the basis of the conditional expression (B). Two path selection methods are shown below.

(1) The number of gateways which execute path setting processing can be lowered by switching paths from a security gateway that provides for a plurality of subscribers to a security gateway that provides for a lower number of subscribers. Also, the number of gateways which execute path setting processing can be lowered by switching paths from a gateway in which the volume of traffic is higher than gateways in its vicinity. Accordingly the security server monitoring device 100 selects the needed number of security gateways in a sequence that is according to which security gateways have the larger number of subscribers or the larger traffic volume. By selecting a security gateway, the paths that are set by the security gateway are selected. Information concerning the number of subscribers in each security gateway is stored in advance in the security server monitoring device 100, and the traffic volume, gathered by the security server 10, in the vicinity of each security gateway is also stored.

More specifically, the security server monitoring device 100 executes the calculation below on each security gateway.

Calculation Formula (C): X=b multiplied by the number of accommodated subscribers plus c multiplied by the traffic volume (b and c are weighting factors) The security server monitoring device 100 calculates X using the calculation formula (C), in which X is a value for each security gateway in which paths are set for a security server in which determination has been made that a need exists for a change in allocation. Then the security server monitoring device 100 selects the security gateways (more specifically, the paths set in the security gateways) allocated to the reallocation security servers in order from the largest value of X, selecting security gateways until the total value of the X values of the selected security gateways exceeds a predetermined threshold value Y, more specifically, as long as the conditional expression below is satisfied.

Conditional expression (D): Y>ΣX

For example, when the security gateways are selected in order from the largest values of X, and when the fifth selected security gateway causes the conditional expression (D) to be satisfied, the first five security gateways are selected, and the paths of the selected security gateways are switched to the reallocation servers.

(2) A shortest path search algorithm such as the so-called Dijkstra's algorithm is applied to calculate the network link costs from the selected allocation security servers to each security gateway, and security gateways with link costs lower that a threshold value “a” are selected.

More specifically, security gateways satisfying the conditional expression below are selected.

Conditional expression (E): a>network link costs

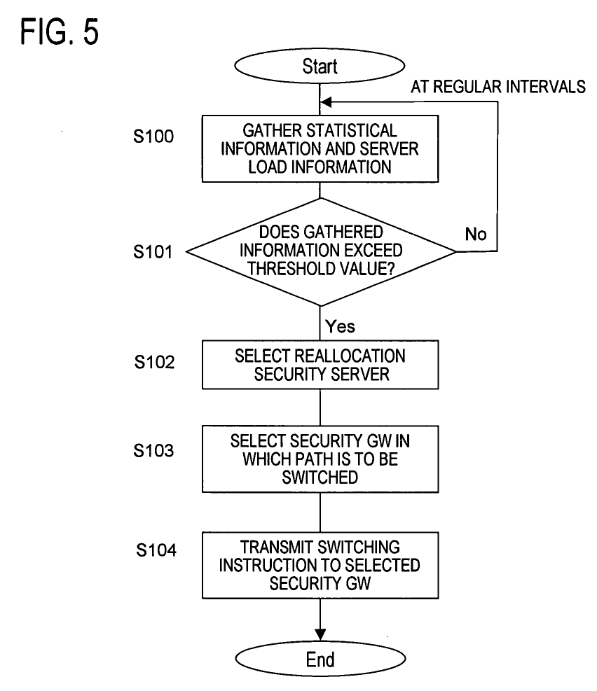

FIG. 5 is a drawing showing a flow chart of the processing performed in the security server monitoring device. The security server monitoring device 100 gathers server load information and statistical information relating to viruses, from each security server (S100). Then the security server monitoring device 100 executes the allocation change determination method described above on the basis of the gathered information. For example, the security server monitoring device 100 determines on the basis of the conditional expression (A) whether the gathered information exceeds the threshold value (S101). Steps S100 and S101 are executed at regular intervals (for example, every minute) even when determination is made that a change in allocation is not needed (the threshold value has not been exceeded).

When a determination is made in step S101 that a change of allocation is needed, the security server monitoring device 100 executes the selection method for a reallocation security server described above, and selects a reallocation security server on the basis of, for example, conditional expression (B) (S102).

Furthermore, the security server monitoring device 100 executes the path selection method described above to select paths to be allocated to the reallocation server, from among security gateways in which paths of security servers are set in which the need for a change in allocation has been determined. For example, the security server monitoring device 100 selects, on the basis of the conditional expressions (C) and (D), security gateways in which paths are set to be allocated to the reallocation security server (S103).

Then the security server monitoring device 100 transmits a path switching instruction for the reallocation security server selected in step S102 to the security gateways selected in step S103 (S104).

The security gateways which receive the path switching instruction switch the paths according to the path switching instruction.

When a vaccine has been disclosed for the virus which caused a change in allocation for the security servers, a gradual reduction in traffic volume can be predicted, thus, for example, the security gateways that have been switched to the reallocation security server may be switched in stages back to the original security servers. Also, when a vaccine is disclosed while paths are being switched to the reallocation security servers, the security server monitoring device 100 may monitor the server load information and the statistical information relating to viruses, and temporarily stop the switching of paths.

When the security server 10 executes the allocation change determination method, the security server 10 executes steps S100 and S101 in FIG. 5, notifies the security server monitoring device 100 of the determination result when the security server 10 determines that a change of allocation is needed, and on the basis of this notification, the security server monitoring device 100 executes the processing from step S102 and on. In this case, the security server monitoring device 100 gathers server load information and statistical information concerning viruses, from each security server.

Also, the paths to the security servers are not limited to cases in which a security gateway is set, but may include a case in which the paths are set directly to the subscriber terminals. In this case, the subscriber terminals would perform switching of the paths to the reallocation security servers.

What is claimed is:

1. A security server monitoring device for monitoring the load on a first security server which is allocated to a path in a network and which checks for computer viruses included in data flowing through the path, the security server monitoring device comprising:
a gathering unit for gathering statistical information, from the first security server, relating to computer viruses in the first security server;
a determination unit for determining whether a load condition of the first security server exceeds a first load level on the basis of the statistical information relating to the first security server; and
an allocation unit for allocating a second security server to the path in place of the first security server when the determination unit determines that the load condition of the first security server exceeds the first load level.

2. The security server monitoring device according to claim 1, wherein
the gathering unit gathers statistical information relating to the second security server,
the determination unit determines whether the load condition of the second security server is less than a second load level on the basis of statistical information relating to the second security server, when the determination unit determines that the load condition of the first security server exceeds a fixed load level, and
when the determination unit has determined that the load condition of the second security server is less than the second load level, the allocation unit selects the second security server from among a plurality of security servers which are not the first security server, and allocates the second security server to the path.

3. The security server monitoring device according to claim 1, wherein the allocation unit allocates the second security server to a portion of a plurality of paths to which the first security server is allocated.

4. The security server monitoring device according to claim 3, wherein the allocation unit selects the portion of the paths on the basis of the number of subscribers accommodated in each path or on the basis of the communication volume of each path.

5. The security server monitoring device according to claim 3, wherein the allocation unit selects the portion of the paths on the basis of the network link costs for each path to the second security server.

6. The security server monitoring device according to claim 1, wherein
the gathering unit gathers load information relating to the first security server from the first security server, and
the determination unit determines whether the load condition of the first security server exceeds the first load level on the basis of the statistical information and the load information relating to the first security server.

7. The security server monitoring according to claim 2, wherein
the gathering unit gathers load information relating to the second security server from the second security server, and the determination unit determines the load condition of the second security server on the basis of the statistical information and the load information relating to the second security server.

8. The security server monitoring device according claim 1, wherein the statistical information includes information relating to the number or rate of computer virus infections detected in a unit of time.

9. The security server monitoring device according to claim 8, wherein the statistical information includes information relating to the infection levels or the degree of danger of the detected computer viruses.

10. A load distribution system having: a first security server which is allocated to a path in a network and which checks for computer viruses included in data flowing through the path; and a security server monitoring device which monitors the load of the first security server, wherein
the first security server comprises:
a generating unit for generating statistical information relating to computer viruses on the basis of a computer virus check result;
a first determination unit for determining whether the load condition of the first security server exceeds a first load level on the basis of statistical information relating to the first security server; and
a notification unit for notifying the security server monitoring device of the determination result when the first determination unit determines that the load condition of the first security server exceeds the first load level, and
the security server monitoring device comprises:
a receiving unit for receiving the determination result from the notification unit; and
an allocation unit for allocating a second security server to the path in place of the first security server when the determination result is received.

11. The load distribution system according to claim 10, wherein the security server device comprises:
a gathering unit for gathering statistical information relating to the second security server on the basis of the determination result received by the receiving unit; and
a second determination unit for determining whether the load condition of the second security server is less than a second load level on the basis the statistical information relating to the second security server, and
when the second determination unit determines that the load condition of the second security server is less than the second load level, the allocation unit selects the second security server from among a plurality of security servers which are not the first security server, and allocates the second security server to the path.

12. The load distribution system according to claim 10, wherein the allocation unit allocates the second security server to a portion of a plurality of paths allocated to the first security server.

13. The load distribution system according to claim 12, wherein the allocation unit selects the portion of the paths on the basis of the number of subscribers accommodated in each path or on the basis of the communication volume of each path.

14. The load distribution system according to claim 12, wherein the allocation unit selects the portion of the paths on the basis of the network link costs for each path to the second security server.

15. The load distribution system according to claim 10, wherein
the generating unit generates load information relating to the first security server, and
the first determination unit determines whether the load condition of the first security server exceeds the first load level on the basis of the statistical information and the load information relating to the first security server.

16. The load distribution system according to claim 11, wherein
the gathering unit gathers load information relating to the second security server from the second security server, and
the second determination unit determines whether the load condition of the second security server is less than the second load level on the basis of the statistical information and the load information relating to the second security server.

17. The load distribution system according to claim 10, wherein the statistical information includes information relating to the number or rate of computer virus infections detected in a unit of time.

18. The load distribution system according to claim 17, wherein the statistical information includes information relating to the infection levels or the degree of danger of the detected computer viruses.
